(19) United States
(12) Patent Application Publication
(10) Pub. No.: US 2020/0258138 A1
(43) Pub. Date: Aug. 13, 2020

(54) SYSTEMS AND METHODS FOR OPTIMIZING VEHICLE SHARING POOLS

(71) Applicant: TOYOTA MOTOR NORTH AMERICA, INC., Plano, TX (US)

(72) Inventor: HAZEM AHMED, Plano, TX (US)

(21) Appl. No.: 16/273,977

(22) Filed: Feb. 12, 2019

(51) Int. Cl. G06Q 30/06; B60W 40/09

(52) U.S. Cl. CPC G06Q 30/0631; B60W 2540/30; B60W 40/09; G06Q 30/0645

(57) ABSTRACT

Systems and methods to optimize vehicle sharing pools are disclosed. Exemplary implementations may: generate output signals conveying driving pattern information associated with a driver operating a vehicle; determine, based on the output signals, driving pattern information; build, based on driving pattern information, driver profile associated with driver; store the driver profile to at least one or more electronic storage units; analyze the driver profile associated with the driver; determine, based on the driver profile analysis and available vehicles of a vehicle inventory associated with the vehicle sharing pool, a proposed vehicle that comports with at least some of the values of the vehicle operational parameters and some of the values of the usage parameters of the driver; and generate, based on the proposed vehicle determined, a suggestion for the driver.

### FIELD OF INVENTION

The present disclosure relates generally to systems and methods for optimizing vehicle sharing pools, and more specifically, some implementations relate to optimizing vehicle sharing pools based on an analysis of driving patterns of a driver.

### BACKGROUND

A plurality of vehicle rental companies (e.g., Zipcar, Greenwheels, Eni, Hertz, and Enterprise) currently exist that may provide vehicle sharing services. However, these companies do not provide solutions based on data analytics to enhance the vehicle sharing experience for each driver, and his/her passengers, in a vehicle sharing pool.

### BRIEF SUMMARY OF EMBODIMENTS

One aspect of the present disclosure relates to a system configured to optimize vehicle sharing pools. The system may include one or more hardware processors configured by machine-readable instructions. Sensor(s) may be configured to generate output signals conveying driving pattern information associated with a driver operating a vehicle. The processor(s) may be configured to determine, based on output signals, driving pattern information associated with the driver. Driving pattern information may characterize at least one of vehicle operations by the driver and usage of the vehicle by the driver in terms of values of vehicle operational parameters and values of usage parameters. The processor(s) may be configured to build, based on the driving pattern information, a driver profile associated with the driver. The processor(s) may be configured to store the driver profile to at least one or more electronic storage units. The processor(s) may be configured to analyze the driver profile associated with the driver. The processor(s) may be configured to determine a proposed vehicle. The propose vehicle may comport with at least some of the values of the vehicle operational parameters and some of the values of the usage parameters of the driver. Determination may be based on the driver profile analysis and available vehicles of a vehicle inventory associated with the vehicle sharing pool. The processor(s) may be configured to generate a suggestion of the proposed vehicle determined for the driver.

As used herein, the term “determine” (and derivatives thereof) may include measure, calculate, compute, estimate, approximate, generate, and/or otherwise derive, and/or any combination thereof.

Another aspect of the present disclosure relates to a method to optimize vehicle sharing pools. The method may include generating output signals conveying driving pattern information associated with a driver operating a vehicle. The method may include determining, based on output signals, driving pattern information associated with the driver. Driving pattern information may characterize at least one of vehicle operations by the driver and usage of the vehicle by the driver in terms of values of vehicle operational parameters and values of usage parameters. The method may include building, based on the driving pattern information, a driver profile associated with the driver The method may include storing the driver profile to at least one or more electronic storage units. The method may include analyzing the driver profile associated with the driver. The method may include determining a proposed vehicle. The propose vehicle may comport with at least some of the values of the vehicle operational parameters and some of the values of the usage parameters of the driver. Determination may be based on the driver profile analysis and available vehicles of a vehicle inventory associated with the vehicle sharing pool. The method may include generating a suggestion of the proposed vehicle determined for the driver.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates an example vehicle in which embodiments of the disclosed technology may be implemented.

FIG. 2 illustrates a system configured to optimize vehicle sharing pools, in accordance with one or more implementations.

FIG. 3 illustrates a method for optimizing vehicle sharing pools, in accordance with one or more implementations.

FIG. 4 illustrates a method for optimizing vehicle sharing pools, in accordance with one or more implementations.

### DETAILED DESCRIPTION OF THE EMBODIMENTS

Implementations of the disclosure are directed to optimizing vehicle sharing pools The system may determine and analyze how the driver operates and uses a vehicle to determine a proposed vehicle for a driver's subsequent vehicle use. In some implementations, at least one of the driver's input and calendar information is considered in determination. Based on the analysis, the system may generate and effectuate a suggestion of the proposed vehicle for the driver.

Implementations of the disclosure are further directed to determining a usage suggestion for the driver. The system may determine and analyze how the driver operates and uses a vehicle to determine a suggestion to implement on a subsequent vehicle use. All captured information, may be stored to a respective driver profile in electronic storage.

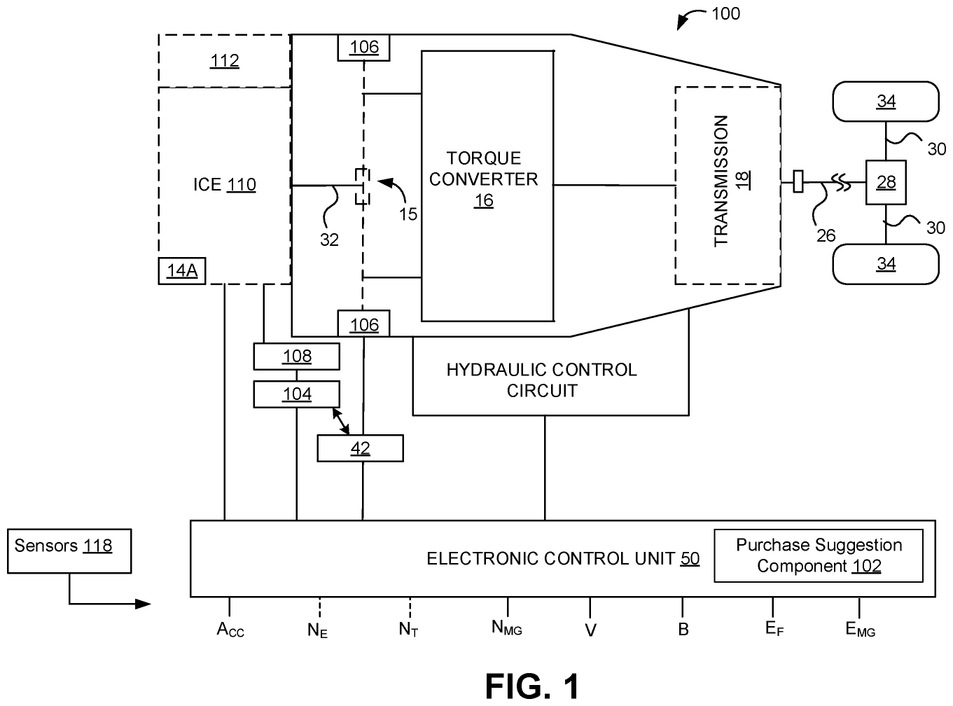

FIG. 1 illustrates an example vehicle 100 in which embodiments of the disclosed technology may be implemented to optimize vehicle sharing pools for participants of the vehicle pool (i.e., drivers). It should be appreciated that implementations described herein are not limited to the vehicle type illustrated by FIG. 1, and that implementations described herein may be implemented in any vehicle having the necessary components to optimize vehicle sharing pools in accordance with implementations described herein.

Vehicle 100 may include an internal combustion engine 110 and one or more electric motors 106 (which may also serve as generators) as sources of motive power. Driving force generated by the internal combustion engine 110 and motor 106 can be transmitted to one or more wheels 34 via a torque converter 16, a transmission 18, a differential gear device 28, and a pair of axles 30.

Vehicle 100 may be driven/powered with either or both of engine 110 and the motor(s) 106 as the drive source for travel. For example, a first travel mode may be an engine-only travel mode that only uses internal combustion engine 110 as the drive source for travel. A second travel mode may be an EV travel mode that only uses the motor(s) 106 as the drive source for travel. A third travel mode may be an HEV travel mode that uses engine 110 and the motor(s) 106 as drive sources for travel.

Engine 110 can be an internal combustion engine such as a spark ignition (SI) engine (e.g., gasoline engine) a compression ignition (CI) engine (e.g., diesel engine) or similarly powered engine (whether reciprocating, rotary, continuous combustion or otherwise) in which fuel is injected into and combusted to provide motive power. A cooling system 112 can be provided to cool the engine such as, for example, by removing excess heat from engine 110. For example, cooling system 112 can be implemented to include a radiator, a water pump and a series of cooling channels.

An output control circuit 14A may be provided to control drive (output torque) of engine 110. Output control circuit 14A may include a throttle actuator to control an electronic throttle valve that controls fuel injection, an ignition device that controls ignition timing, and the like. Output control circuit 14A may execute output control of engine 110 according to a command control signal(s) supplied from an electronic control unit 50, described below. Such output control can include, for example, throttle control, fuel injection control, and ignition timing control.

Motor 106 can also be used to provide motive power in vehicle 100, and is powered electrically via a battery 104. Battery 104 may be implemented as one or more batteries or other power storage devices including, for example, lead-acid batteries, lithium ion batteries, capacitive storage devices, and so on. Battery 104 may be charged by a battery charger 108 that receives energy from internal combustion engine 110. For example, an alternator or generator may be coupled directly or indirectly to a drive shaft of internal combustion engine 110 to generate an electrical current as a result of the operation of internal combustion engine 110. A clutch can be included to engage/disengage the battery charger 108. Battery 104 may also be charged by motor 106 such as, for example, by regenerative braking or by coasting during which time motor 106 operate as generator.

Motor 106 can be powered by battery 104 to generate a motive force to move the vehicle and adjust vehicle speed. Motor 106 can also function as a generator to generate electrical power such as, for example, when coasting or braking. Battery 104 may also be used to power other electrical or electronic systems in the vehicle. Motor 106 may be connected to battery 104 via an inverter 42. Battery 104 can include, for example, one or more batteries, capacitive storage units, or other storage reservoirs suitable for storing electrical energy that can be used to power motor 106. When battery 104 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 106, and adjust the current received from motor 106 during regenerative coasting and breaking. As a more particular example, output torque of the motor 106 can be increased or decreased by electronic control unit 50 through the inverter 42.

A torque converter 16 can be included to control the application of power from engine 110 and motor 106 to transmission 18. In other embodiments, a mechanical clutch can be used in place of torque converter 16.

Clutch 15 can be included to engage and disengage engine 110 from the drivetrain of the vehicle. In the illustrated example, a crankshaft 32, which is an output member of engine 110, may be selectively coupled to the motor 106 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch.

Vehicle 100 may include sensor 118, electronic control unit 50, and/or other components.

Electronic control unit 50 may include circuitry to control various aspects of the vehicle's operation. Electronic control unit 50 may include, for example, a microcomputer that includes one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control component, a powertrain control component, a transmission control component, a suspension control component, a body control component, and so on. These various control units can be implemented using two or more separate electronic control units, or using a single electronic control unit.

In the example illustrated in FIG. 1, electronic control unit 50 receives information from a plurality of sensors 118 included in vehicle 100. Sensors 118 may be configured to generate output signals conveying driving pattern information associated with a driver operating vehicle 100. The driving pattern information may characterize at least one of vehicle operations by the driver and usage of the vehicle by the driver. Vehicle operations may be defined by parameter values of vehicle operational parameters and usage parameters. Vehicle operational parameters may include the vehicle's speed, acceleration, brake engagement, steering wheel position, time derivatives of steering wheel position, throttle, time derivatives of throttle, gear, exhaust, revolutions per minutes, mileage, emissions, and/or other vehicle operations. Usage parameters may include vehicle capacity information (e.g., passenger amount, animal amount (e.g., pets), etc.), type(s) of roadways travelled on, purpose of vehicle use, distances travelled per use, travel time, frequency of the distances travelled, frequency of the travel times, frequency of vehicle use, ambient conditions, and/or other usage parameters. Ambient conditions may include external temperature, rain, hail, snow, fog, and/or other naturally occurring conditions. Types of roads travelled may include highway, city streets, unpaved (e.g., dirty, sand, mud, etc.), and/or other types of roads. In some embodiments, one or more of the sensors 118 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 118 may provide an analog output or a digital output.

Sensors 118 may include, by way of example, one or more of an altimeter (e.g. a sonic altimeter, a radar altimeter, and/or other types of altimeters), a barometer, a magnetometer, a pressure sensor (e.g. a static pressure sensor, a dynamic pressure sensor, a pitot sensor, etc.), a thermometer, an accelerometer, a gyroscope, an inertial measurement sensor, global positioning system sensors, a tilt sensor, a motion sensor, a vibration sensor, an image sensor, a camera, a depth sensor, a distancing sensor, an ultrasonic sensor, an infrared sensor, a light sensor, a microphone, an air speed sensor, a ground speed sensor, an altitude sensor, medical sensors (including but not limited to blood pressure sensor, pulse oximeter, heart rate sensor, etc.), degree-of-freedom sensors (e.g. 6-DOF and/or 9-DOF sensors), a compass, and/or other sensors. As used herein, the term “sensor” may include one or more sensors configured to generate output conveying information related to position, location, distance, motion, movement, acceleration, and/or other motion-based parameters. Output signals generated by individual sensors (and/or information based thereon) may be stored and/or transferred in electronic files. In some implementations, output signals generated by individual sensors (and/or information based thereon) may be streamed to one or more other components of vehicle 100.

Sensors 118 may further include image sensors, cameras, and/or other sensors. As used herein, the terms “image sensor”, “camera” and/or “sensor” may include any device that captures images, including but not limited to a single lens-based camera, a camera array, a solid-state camera, a mechanical camera, a digital camera, an image sensor, a depth sensor, a remote sensor, weight sensor, a lidar, an infrared sensor, a (monochrome) complementary metal-oxide-semiconductor (CMOS) sensor, an active pixel sensor, and/or other sensors. Individual sensors may be configured to capture information, including but not limited to visual information, video information, audio information, geolocation information, orientation and/or motion information, depth information, and/or other information. Information captured by one or more sensors may be marked, timestamped, annotated, and/or otherwise processed such that information captured by other sensors can be synchronized, aligned, annotated, and/or otherwise associated therewith. For example, video information captured by an image sensor may be synchronized with information captured by an accelerometer or other sensor. Output signals generated by individual image sensors (and/or information based thereon) may be stored and/or transferred in electronic files.

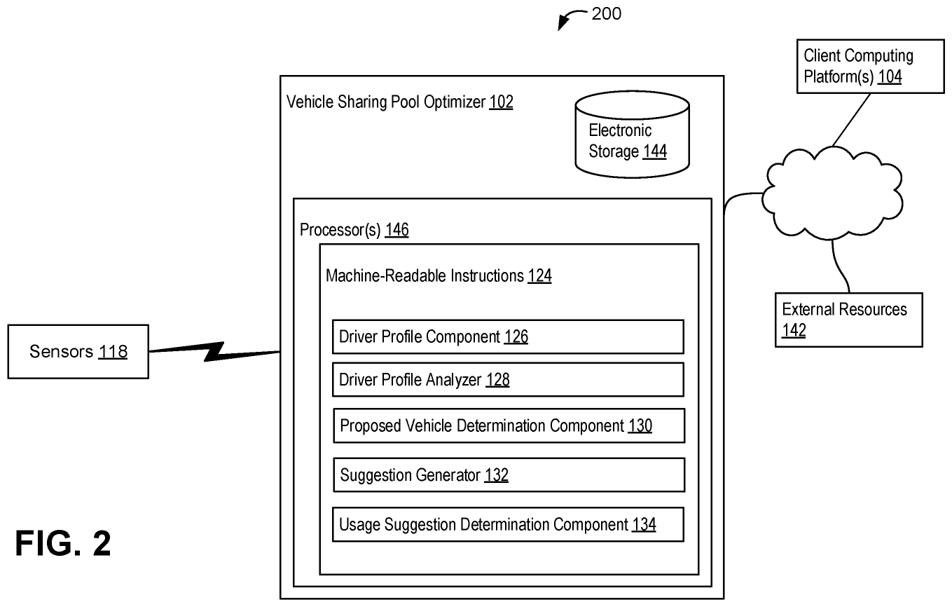

FIG. 2 illustrates an example architecture for automatic optimization of vehicle sharing pools in accordance with one embodiment of the systems and methods described herein. Referring now to FIG. 2, in this example, a vehicle 100 includes a vehicle sharing pool optimizer 102, and a plurality of sensors 118. Sensors 118 can communicate with vehicle sharing pool optimizer 102 via a wired or wireless communication interface. Although sensors 118 are depicted as communicating with vehicle sharing pool optimizer 102, they can also communicate with each other as well as with other vehicle systems. Vehicle sharing pool optimizer 102 can be implemented as an ECU or other circuit, or as part of an ECU such as, for example electronic control unit 50. In other embodiments, vehicle sharing pool optimizer 102 can be implemented independently of the ECU (e.g., as a dedicated optimizer circuit or circuit with other shared functions). In still further embodiments, vehicle sharing pool optimizer 102 can be implemented in whole or in part as a cloud based solution.

FIG. 2 includes a block diagram illustrating example components of a vehicle sharing pool optimizer 102, in accordance with one or more implementations. Vehicle sharing pool optimizer 102 may be configured to communicate with one or more client computing platforms 104 according to a client/server architecture and/or other architectures. Client computing platform(s) 104 may be configured to communicate with other client computing platforms via vehicle sharing pool optimizer 102 and/or according to a peer-to-peer architecture and/or other architectures. Users may access system 200 via individual ones of the client computing platform(s) 104. By way of non-limiting illustration, client computing platform(s) 104 may be configured to obtain information from vehicle sharing pool optimizer 102 to effectuate presentation of user interfaces on the client computing platform(s) 104. The vehicle sharing pool optimizer 102 may be configured to obtain information from client computing platform(s) 104 via user input into the user interfaces.

Vehicle sharing pool optimizer 102 may be configured by machine-readable instructions 124. Machine-readable instructions 124 may include one or more instruction components. The instruction components may include computer program components. The instruction components may include one or more of a driver profile component 126, a driver profile analyzer 128, a proposed vehicle determination component 130, a suggestion generator 132, a usage suggestion determination component 134, and/or other instruction components.

Driver profile component 126 may be configured to determine, based on output signals, driving pattern information of the driver of the vehicle. Driving pattern information may include the parameter values of vehicle operational parameters and parameter values of usage parameters characterizing at least one of vehicle operations by the driver and usage of the vehicle by the driver. Determination may include identifying the parameter values of the vehicle operational parameters and the usage parameters. Determination may include identifying parameter values of the vehicle operational parameters and/or usage parameters that are normal, abnormal, near abnormal, and/or within thresholds. Determining values that are abnormal, for example, may be saved to the driver profile of the driver such that the values may be considered for future vehicle uses from the vehicle pool. Determination may include identifying whether the driver is a safe driver, unsafe driver, aggressive driver, unaggressive driver, and/or others. Determination may include converting the values of the vehicle operational parameters and/or usage parameters to other values readable by one or more components of vehicle sharing pool optimizer 102.

Driver profile component 126 may further be configured to build the driver profile of the driver. The driver profile may include the determined driving pattern information associated with the driver. Driver profile component 126 may further be configured to store the driving pattern information determined to one or more electronic storage units 144 to the driver's profile. The driver profiles may be stored permanently, temporarily, or for calculated amount of time.

By way of example, driver profile component 126 may determine driving pattern information associated with a driver. The driving pattern information may be defined by values of vehicle operational parameters and usage parameters including, for example, an average speed (e.g., average speed of 70 MPH), level of brake engagement (e.g., high brake engagement), roadway type (e.g., highway, city street, rural Road, dirt road, etc.), average distance traveled per use (e.g., actual quantity or ranges), frequency of driving (e.g., number of days per week, number of hours per day, number of trips per day, and so on), acceleration and braking style (e.g., gentle or aggressive acceleration; soft or hard braker), cornering style (e.g., high-g or low-g cornering), driving style (e.g., aggressive, mild, normal), number of accidents in which the driver has been involved, number of tickets received by the driver, whether the driver typically carries passengers (e.g., as determined by sensor information), returned-vehicle conditions as noted by an attendant or subsequent renter (e.g., dirty vehicle, smells and vehicle, pet hairs in vehicle, damage to vehicle, interior stains, and so on) and other like information.

When the driver reserves a vehicle, the driver profile can be consulted and a vehicle chosen based on the driver profile. As one example, where the driver is identified as an aggressive driver on his/her driver profile based on the driving pattern information, an appropriate vehicle type match to the driver might be, for example, an older vehicle with higher miles that has already sustained wear and tear. As another example, for a driver identified as an unsafe driver or a driver who engages in late emergency braking, a vehicle with automatic emergency braking (AEB) and 5-star crash test rating may be optimal for the driver.

By way of another example, a driver may cease to enter driver input for an upcoming event with a guest. Based on the driving pattern information, driver profile component 126 determines the driver often travels on unpaved roadways. Proposed vehicle determination component 130 may propose a sports utility vehicle (SUV) based solely on the driving pattern information rather than a smaller vehicle sufficient for two people.

Driver profile analyzer 128 may be configured to analyze the driver profile. Analysis of the driver profile of the driver may assistant with determination of an optimal vehicle for the driver for subsequent uses. Analysis of the driver profile of the driver may include consideration of the driving pattern information stored to the driver profile. Driver profile analyzer 128 may utilize data analytic techniques, machine learning, formulas, and/or other methods of analysis. In some implementations, driver profile analyzer 128 may analyze some information before others. By way of example, vehicle operations of by the driver (i.e., values of vehicle operational parameters) may be analyzed, followed by usage of the vehicle by the driver (i.e., values of usage parameters), and followed by other information stored to the driver profile.

Proposed vehicle determination component 130 may be configured to determine a proposed vehicle. The determination may be based on the analysis of the driver profile for that driver and available vehicles of a vehicle inventory associated with a vehicle sharing pool. The proposed vehicle may comport with at least some of the values of the vehicle operational parameters and some of the values of the usage parameters of the driver. The vehicle sharing pool may be a fleet of vehicles available for driver's to use upon availability. Proposed vehicle determination component 130 may, by way of example, determine a first vehicle or class of vehicles optimal for the driver of the vehicle inventory of the vehicle sharing pool. However, the first vehicle may be in use by another driver. Proposed vehicle determination component 130 may determine one or more alternative vehicles to propose to the driver. In some implementations, proposed vehicle determination component 130 may determine a plurality of proposed vehicles or classes of vehicles, from most optimal to least, for the driver.

In some implementations, proposed vehicle determination component 130 may be configured to receive driver input and use this input as part of the decision-making process. Driver input may include a vehicle request, quality of vehicle as received, improvement suggestions for vehicle sharing pool optimizer 102, feedback surveys prompted to the driver, and/or other inputs. Vehicle requests may be defined by values of one or more vehicle feature parameters. Vehicle feature parameters may include vehicle type, vehicle size, occupancy capacity, driving modes, vehicle trunk capacity, vehicle accessories, color, number of doors, fuel efficiency levels, and/or others. Vehicle accessories may include one or more entertainment systems (e.g., overhead DVD player(s), in-seat DVD players, in-vehicle WIFI, wireless connectivity for mobile devices, etc.), backup camera(s), 360 view cameras, fog lights, automatic high beams, dual-zone automatic climate control, USB ports, automatic emergency braking (AEB), heated front and rear seats, lane change assist, blind spot warning, all-wheel-drive, automatic transmission, and/or other vehicle accessories. Proposed vehicle determination component 130 may be configured to determine a proposed vehicle based on the driver input of the driver in addition to the driving pattern information, and these may be applied to the available vehicles of the vehicle inventory. By way of example, a driver may input values of vehicle feature parameters they prefer for a vehicle for an upcoming road trip. The values of the vehicle feature parameters may include in-seat DVD players, fuel efficiency of 30+ miles-per-gallon, backup cameras, and USB ports.

The proposed vehicle may comport with at least some of the values of the vehicle feature parameters. The available vehicles of the vehicle inventory may include values of the vehicle feature parameters in which the values of the vehicle features parameters based on the driver input comport with. Upon no driver input, the proposed vehicle determination component 130 may base determination solely on driving pattern information.

In some implementations, weighting factors can be assigned to some or all of the driver parameters in the profile and driver selections so that these various parameters can be weighted differently when selecting a vehicle. For example, the driver profile may carry a stronger weight than the driver selections. In an example implementation, the driver profile may dictate a vehicle or plurality of vehicles suitable for that profile, and the driver selections may influence or dictate selection of a specific vehicle within that plurality vehicles suitable for the profile. As another example, individual parameters in the driver profile may carry more weight than other parameters. Further to this example, parameters have to do with safety or risk may be weighted heavier than other parameters.

In some implementations, proposed vehicle determination component 130 may be configured to access calendar information of the driver. The calendar information may be defined by parameter values of calendar parameters. The calendar parameters may include scheduled locations to travel to, dates (e.g., start dates and end dates), times (e.g., start times and end times), durations of visits, and/or other calendar parameters. Proposed vehicle determination component 130 may be configured to determine a proposed vehicle based on the calendar information of the driver in addition to the available vehicles of the vehicle inventory. The proposed vehicle may comport with at least some of the values of the operational parameters, the values of the usage parameters of the driver, and the values calendar parameters such that the proposed vehicle may be scheduled for a driver's future used based on his/her calendar.

By way of example, a driver may have on his/her calendar a scheduled party included in his/her calendar information. The calendar information may further be defined by values of calendar parameters including the party is scheduled on a Friday, at a time of 6 PM-9 PM, and 50 miles away based on the location. Proposed vehicle determination component 130 may determine a hybrid vehicle is optimal in that the driver will travel a roundtrip of 100 miles and 50 of the miles during traffic time. Furthermore, a crossover-sized vehicle may be proposed based on driver input that the proposed vehicle must accommodate four people and have medium trunk capacity.

Suggestion generator 132 may be configured to generate a suggestion for the driver. The suggestion may be based on the proposed vehicle determined. The suggestion may include one or more proposed vehicles optimal for the driver. In some implementations, the suggestion for the driver may be a usage suggestion such that the quality of the vehicle is maintained, as described below. Suggestion generator 132 may further be configured to effectuate presentation of the suggestion to the driver.

Usage suggestion determination component 134 may be configured to determine usage suggestions for the driver for subsequent vehicle uses. The usage suggestions may help to maintain the quality of the vehicle. Determination of the usage suggestions may be based on the driver pattern information. In some implementations, determination of the usage suggestions may be based on the driving pattern information and driver input. The driver input may be from the driver who is using the vehicle. The driver input may characterize the quality of the vehicle as it was left by a previous driver. By way of example, usage suggestions for the driver may include to vacuum at end of use, lay sheet on seats for animals, wash at end of use, leave a scented freshener at end of use, and/or other usage suggestions. In further implementations, the suggestions may be implemented as mandatory rather than just suggestions, and their mandatory nature may be enforced, for example, by fines, cleaning fees, excess rental charges. Additionally, the failure to follow suggestions may be noted in the driver's profile and this information may be considered when making subsequent vehicle determinations.

In some implementations, vehicle sharing pool optimizer 102, client computing platform(s) 104, and external resources 142 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which vehicle sharing pool optimizer 102, client computing platform(s) 104, and external resources 142 may be operatively linked via some other communication media.

A given client computing platform 104 may include one or more processors configured to execute computer program components. The computer program components may be configured to enable an expert or user associated with the given client computing platform 104 to interface with system 100 and/or external resources 138, and/or provide other functionality attributed herein to client computing platform(s) 104. By way of example, the given client computing platform 104 may include one or more of a desktop computer, a laptop computer, a handheld computer, a NetBook, a mobile computing platform (e.g., a Smartphone, a tablet computing platform), a gaming console, and/or other computing platforms.

External resources 142 may include sources of information outside of vehicle sharing pool optimizer 102, external entities participating with vehicle sharing pool optimizer 102, and/or other resources. In some implementations, some or all of the functionality attributed herein to external resources 142 may be provided by resources included in vehicle sharing pool optimizer 102.

Vehicle sharing pool optimizer 102 may include electronic storage 144, one or more processors 146, and/or other components. Vehicle sharing pool optimizer 102 may include communication lines, or ports to enable the exchange of information with a network and/or other computing platforms. Illustration of vehicle sharing pool optimizer 102 in FIG. 2 is not intended to be limiting. Vehicle sharing pool optimizer 102 may include a plurality of hardware, software, and/or firmware components operating together to provide the functionality attributed herein to vehicle sharing pool optimizer 102. For example, vehicle sharing pool optimizer 102 may be implemented by a cloud of computing platforms and/or servers operating together as vehicle sharing pool optimizer 102.

Electronic storage 144 may comprise non-transitory storage media that electronically stores information. The electronic storage media of electronic storage 144 may include one or both of system storage that is provided integrally (i.e., substantially non-removable) with vehicle sharing pool optimizer 102 and/or removable storage that is removably connectable to vehicle sharing pool optimizer 102 via, for example, a port (e.g., a USB port, a firewire port, etc.) or a drive (e.g., a disk drive, etc.). Electronic storage 144 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 144 may include one or more virtual storage resources (e.g., cloud storage, a virtual private network, and/or other virtual storage resources). Electronic storage 144 may store software algorithms, information determined by processor(s) 146, information received from vehicle sharing pool optimizer 102, client computing platform(s) 104, and/or other information that enables vehicle sharing pool optimizer 102 to function as described herein.

Processor(s) 146 may be configured to provide information processing capabilities in vehicle sharing pool optimizer 102. As such, processor(s) 146 may include one or more of a digital processor, an analog processor, a digital circuit designed to process information, an analog circuit designed to process information, a state machine, and/or other mechanisms for electronically processing information. Although processor(s) 146 is shown in FIG. 2 as a single entity, this is for illustrative purposes only. In some implementations, processor(s) 146 may include a plurality of processing units. These processing units may be physically located within the same device, or processor(s) 146 may represent processing functionality of a plurality of devices operating in coordination. Processor(s) 146 may be configured to execute components 126, 128, 130, 132, and/or 134, and/or other components. Processor(s) 146 may be configured to execute components 126, 128, 130, 132, and/or 134, and/or other components by software; hardware; firmware; some combination of software, hardware, and/or firmware; and/or other mechanisms for configuring processing capabilities on processor(s) 146. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 126, 128, 130, 132, and/or 134 are illustrated in FIG. 2 as being implemented within a single processing unit, in implementations in which processor(s) 146 includes multiple processing units, one or more of components 126, 128, 130, 132, and/or 134 may be implemented remotely from the other components. The description of the functionality provided by the different components 126, 128, 130, 132, and/or 134 described below is for illustrative purposes, and is not intended to be limiting, as any of components 126, 128, 130, 132, and/or 134 may provide more or less functionality than is described. For example, one or more of components 126, 128, 130, 132, and/or 134 may be eliminated, and some or all of its functionality may be provided by other ones of components 126, 128, 130, 132, and/or 134. As another example, processor(s) 146 may be configured to execute one or more additional components that may perform some or all of the functionality attributed below to one of components 126, 128, 130, 132, and/or 134.

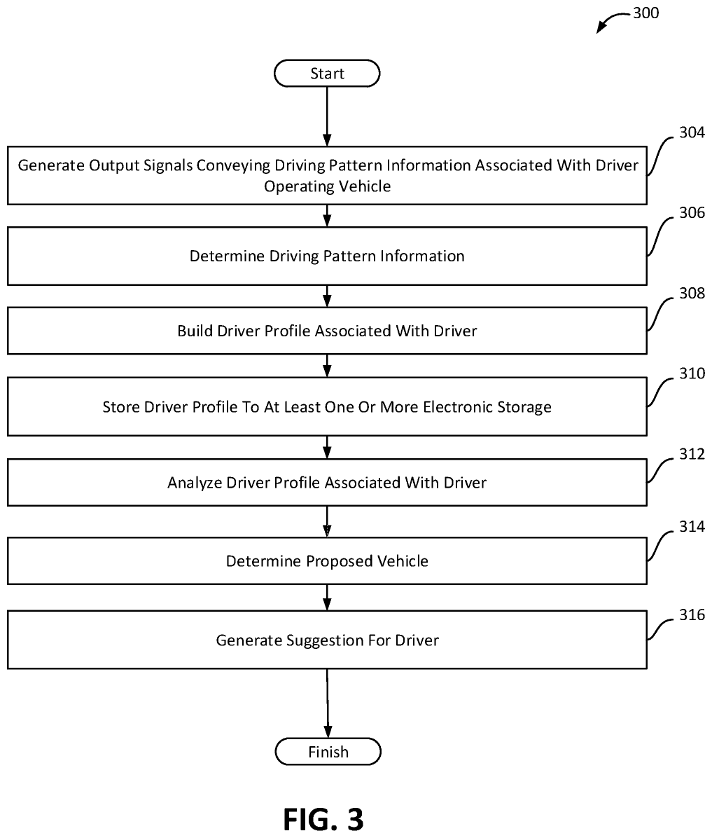

FIG. 3 illustrates a method 300 to optimize vehicle sharing pools, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300A in response to instructions stored electronically on an electronic storage medium. The one or more processing devices may include one or more devices configured through hardware, firmware, and/or software to be specifically designed for execution of one or more of the operations of method 300.

An operation 304 may include generating output signals conveying driving pattern information associated with the driver operating the vehicle. Operation 304 may be performed by one or more hardware processors configured by machine-readable instructions including a component that is the same as or similar to sensors 118, in accordance with one or more implementations.

An operation 306 may include determining the driving pattern information. Determination may be based on the output signals. Operation 306 may be performed by one or more hardware processors configured by machine-readable instructions including a component that is the same as or similar to driver profile component 126, in accordance with one or more implementations.

An operation 308 may include building a driver profile associated with the driver. Operation 308 may be performed by one or more hardware processors configured by machine-readable instructions including a component that is the same as or similar to driver profile component 126, in accordance with one or more implementations.

An operation 310 may include storing the driver profile to at least one or more electronic storage. The driver profile may be stored to electronic storage permanently or temporarily. Operation 310 may be performed by one or more hardware processors configured by machine-readable instructions including a component that is the same as or similar to driver profile component 126, in accordance with one or more implementations.

An operation 312 may include analyzing the driver profile associated with the driver. The driver profile may include the driving pattern information associated with the driver. Operation 312 may be performed by one or more hardware processors configured by machine-readable instructions including a component that is the same as or similar to driver profile analyzer 128, in accordance with one or more implementations.

An operation 314 may include determining a proposed vehicle. The determination may be based on the analysis of the driver profile of the driver and available vehicles of a vehicle inventory associated with a vehicle sharing pool. The proposed vehicle may comport with at least some of the values of the vehicle operational parameters and some of the values of the usage parameters of the driver. Operation 314 may be performed by one or more hardware processors configured by machine-readable instructions including a component that is the same as or similar to proposed vehicle determination component 130, in accordance with one or more implementations.

An operation 316 may include generating a suggestion for the driver. The suggestion may be based on the proposed vehicle determined. Operation 316 may be performed by one or more hardware processors configured by machine-readable instructions including a component that is the same as or similar to suggestion generator 132, in accordance with one or more implementations.

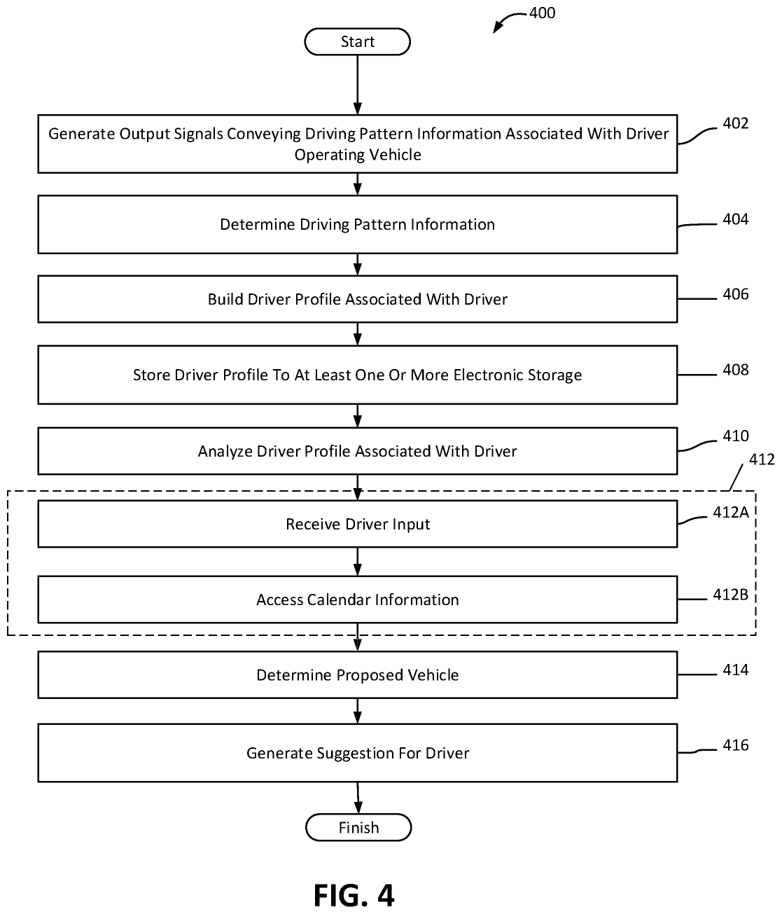

FIG. 4 illustrates a method 400 to optimize vehicle sharing pools, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400A in response to instructions stored electronically on an electronic storage medium. The one or more processing devices may include one or more devices configured through hardware, firmware, and/or software to be specifically designed for execution of one or more of the operations of method 400.

An operation 402 may include generating output signals conveying driving pattern information associated with the driver operating the vehicle. Operation 402 may be performed by one or more hardware processors configured by machine-readable instructions including a component that is the same as or similar to sensors 118, in accordance with one or more implementations.

An operation 404 may include determining the driving pattern information. Determination may be based on the output signals. Operation 404 may be performed by one or more hardware processors configured by machine-readable instructions including a component that is the same as or similar to driver profile component 126, in accordance with one or more implementations.

An operation 406 may include building a driver profile associated with the driver. Operation 406 may be performed by one or more hardware processors configured by machine-readable instructions including a component that is the same as or similar to driver profile component 126, in accordance with one or more implementations.

An operation 408 may include storing the driver profile to at least one or more electronic storage. The driver profile may be stored to electronic storage permanently or temporarily. Operation 408 may be performed by one or more hardware processors configured by machine-readable instructions including a component that is the same as or similar to driver profile component 126, in accordance with one or more implementations.

An operation 410 may include analyzing the driver profile associated with the driver. The driver profile may include the driving pattern information associated with the driver. Operation 410 may be performed by one or more hardware processors configured by machine-readable instructions including a component that is the same as or similar to driver profile analyzer 128, in accordance with one or more implementations.

An operation 412 may include at least one of receiving driver input (i.e., operation 412A) and accessing calendar information of the driver (i.e., operation 412B). Determination of the proposed vehicle may be based on driver input or calendar information of the driver, or both.

An operation 412A may include receiving driver input. The driver input may include a vehicle request. The vehicle request may be defined by values of vehicle feature parameters. Operation 412A may be performed by one or more hardware processors configured by machine-readable instructions including a component that is the same as or similar to proposed vehicle determination component 130, in accordance with one or more implementations.

An operation 412B may include accessing calendar information of the driver. The calendar information may be defined by values of calendar parameters. Operation 412B may be performed by one or more hardware processors configured by machine-readable instructions including a component that is the same as or similar to proposed vehicle determination component 130, in accordance with one or more implementations.

An operation 414 may include determining a proposed vehicle. The determination may be based on the analysis of the driver profile of the driver; driver input or calendar information of the driver, or both; and available vehicles of a vehicle inventory associated with a vehicle sharing pool. The proposed vehicle may comport with at least some of the values of the vehicle operational parameters some of the values of the usage parameters of the driver, some values of the vehicle feature parameters, and some values of the calendar parameters. Operation 414 may be performed by one or more hardware processors configured by machine-readable instructions including a component that is the same as or similar to proposed vehicle determination component 130, in accordance with one or more implementations.

An operation 416 may include generating a suggestion for the driver. The suggestion may be based on the proposed vehicle determined. Operation 416 may be performed by one or more hardware processors configured by machine-readable instructions including a component that is the same as or similar to suggestion generator 132, in accordance with one or more implementations.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system configured to optimize vehicle sharing pools, comprising:
vehicle sensors configured to generate output signals conveying driving pattern information associated with a driver operating a vehicle, the driving pattern information characterizing at least one of vehicle operations by the driver and usage of the vehicle by the driver in terms of values of vehicle operational parameters and values of usage parameters; and
one or more processors configured by machine-readable instructions to:
determine, based on the output signals, the driving pattern information;
build, based on the driving pattern information, a driver profile associated with the driver;
store the driver profile to at least one or more electronic storage units;
analyze the driver profile associated with the driver;
determine, based on the driver profile analysis and available vehicles of a vehicle inventory associated with the vehicle sharing pool, a proposed vehicle that comports with at least some of the values of the vehicle operational parameters and some of the values of the usage parameters of the driver; and
generate, based on the proposed vehicle determined, a suggestion for the driver.

2. The system of claim 1, wherein the one or more processors are further configured to:
receive driver input, wherein the driver input includes a vehicle request, wherein the vehicle request is defined by values of vehicle feature parameters; and
determine, based on the driver input and the available vehicles of the vehicle inventory, the propose vehicle that comports with at least some of the values of the vehicle feature parameters, the available vehicles of the vehicle inventory including values of the vehicle feature parameters in which the values of the vehicle features parameters based on the driver input comport with.

3. The system of claim 2, wherein the vehicle feature parameters include a vehicle type, a vehicle size, an occupancy capacity, driving modes, vehicle trunk capacity, and/or vehicle accessories.

4. The system of claim 1, wherein the one or more processors are further configured to:
access calendar information of the driver, the calendar information defined by values of calendar parameters; and
determine, based on the calendar information and the available vehicles of the vehicle inventory, the proposed vehicle that comports with at least some of the values of the operational parameters, some of the values of the usage parameters of the driver, and some of the values of the calendar parameters.

5. The system of claim 4, wherein the calendar parameters include scheduled locations to travel to, dates, times, and/or durations of visits.

6. The system of claim 1, wherein the one or more processors are further configured to:
determine, based on the driving pattern information, usage suggestions for the driver such that quality of the vehicle is maintained; and
generate the usage suggestions for the driver.

7. The system of claim 1, wherein the vehicle operational parameters include speeds of the vehicle, accelerations of the vehicle, brake engagements of the vehicle, and/or steering angles of the vehicle.

8. The system of claim 1, wherein the usage parameters include types of roadways traveled on, vehicle capacity information, purpose of vehicle use, distances traveled per vehicle use, frequency of the distances traveled per vehicle use, and/or frequency of vehicle uses.

9. A method for optimizing vehicle sharing pools, comprising:
generating output signals conveying driving pattern information associated with a driver operating a vehicle, the driving pattern information characterizing at least one of vehicle operations by the driver and usage of the vehicle by the driver in terms of values of vehicle operational parameters and values of usage parameters;
determining, based on the output signals, the driving pattern information;
building, based on the driving pattern information, a driver profile associated with the driver;
storing the driver profile to at least one or more electronic storage units;
analyzing the driver profile associated with the driver;
determining, based on the driver profile analysis and available vehicles of a vehicle inventory associated with the vehicle sharing pool, a proposed vehicle that comports with at least some of the values of the vehicle operational parameters and some of the values of the usage parameters of the driver; and
generating, based on the proposed vehicle determined, a suggestion for the driver.

10. The method of claim 9, further comprising:
receiving driver input, wherein the driver input includes a vehicle request, wherein the vehicle request is defined by values of vehicle feature parameters; and
determining, based on the driver input and the available vehicles of the vehicle inventory, the propose vehicle that comports with at least some of the values of the vehicle feature parameters, the available vehicles of the vehicle inventory including values of the vehicle feature parameters in which the values of the vehicle features parameters based on the driver input comport with.

11. The method of claim 10, wherein the vehicle feature parameters include a vehicle type, a vehicle size, an occupancy capacity, driving modes, vehicle trunk capacity, and/or vehicle accessories.

12. The method of claim 9, further comprising:
accessing calendar information of the driver, the calendar information defined by values of calendar parameters; and
determine, based on the calendar information and the available vehicles of the vehicle inventory, the proposed vehicle that comports with at least some of the values of the operational parameters, some of the values of the usage parameters of the driver, and some of the values of the calendar parameters.

13. The method of claim 12, wherein the calendar parameters include scheduled locations to travel to, dates, times, and/or durations of visits.

14. The method of claim 9, further comprising:
determining, based on the driving pattern information, usage suggestions for the driver such that quality of the vehicle is maintained; and
generate the usage suggestions for the driver.

15. The method of claim 9, wherein the vehicle operational parameters include speeds of the vehicle, accelerations of the vehicle, brake engagements of the vehicle, and/or steering angles of the vehicle.

16. The method of claim 9, wherein the usage parameters include types of roadways traveled on, vehicle capacity information, purpose of vehicle use, distances traveled per vehicle use, frequency of the distances traveled per vehicle use, and/or frequency of vehicle uses.
